(19) United States
(12) Patent Application Publication
(10) Pub. No.: US 2008/0268209 A1
(43) Pub. Date: Oct. 30, 2008

(54) Optical member for display apparatus and filter for display apparatus having the same

(75) Inventors: Kwang Je Woo, Suwon-si (KR); Moon Ki Han, Cheongju-si (KR); Sung Nim Cho, Seoul (KR); Eui Soo Kim, Suwon-si (KR); Seng Cheol Jung, Suwon-si (KR)

Correspondence Address: MCDERMOTT WILL & EMERY LLP, 600 13TH STREET, N.W., WASHINGTON, DC, 20005-3096, US

(73) Assignee: SAMSUNG CORNING PRECISION GLASS CO., LTD.

(21) Appl. No.: 12/081,970

(22) Filed: Apr. 24, 2008

(30) Foreign Application Priority Data
Apr. 26, 2007 (KR) 10-2007-0040656
Apr. 26, 2007 (KR) 10-2007-0040681

(51) Int. Cl. B32B 3/00; B32B 3/02; B32B 5/16

(52) U.S. Cl. 428/192; 428/195.1; 428/205; 428/206

(57) ABSTRACT

Disclosed are an optical member for a display apparatus and a filter for a display apparatus having the same. The optical member for the display apparatus includes a transparent resin material, and a first optical pattern formed on a surface of the transparent resin material and including a plurality of first shielding parts filled with a light absorbing substance and a conductive substance.

### CROSS-REFERENCE TO RELATED APPLICATION

This application claims the benefit of Korean Patent Application Nos. 10-2007-0040681, filed on Apr. 26, 2007, and 10-2007-0040656, filed on Apr. 26, 2007, in the Korean Intellectual Property Office, the entire disclosures of which are incorporated herein by reference.

### BACKGROUND OF THE INVENTION

1. Field of the Invention

The present invention relates to an optical member for a display apparatus and a filter for a display apparatus having the same, and more particularly, to an optical member for a display apparatus and a filter for a display apparatus having the same, which can improve brightness, improve a contrast ratio in a bright room, widen a viewing angle, and perform an electromagnetic wave-shielding function.

2. Description of Related Art

In general, plasma display panel (hereinafter, referred to as PDP) apparatuses are generally gaining popularity as next-generation display apparatuses to simultaneously satisfy a trend of becoming larger, and of becoming thinner, when compared with cathode-ray tubes (CRTs) representing existing display apparatuses.

The PDP apparatus may display an image using a gas discharge phenomenon, and thus may exhibit superior display characteristics such as display capacity, brightness, contrast, afterimage, viewing angle, and the like. The PDP apparatus may readily become larger in comparison with other display apparatuses, and serve as a light-emitting type thin display apparatus which has suitable characteristics for a high quality digital television. As a result, the PDP apparatus has been used as a representative display apparatus replacing CRTs.

The PDP apparatus generates a gas discharge between electrodes by a direct current (DC) voltage or an alternating current (AC) voltage which are supplied to the electrodes. Here, ultraviolet light is generated. Then, a phosphor is excited by ultraviolet light, thereby emitting light. However, the PDP apparatus has a defect in that an amount of emitted electromagnetic (EM) radiation and near infrared (NI) radiation with respect to a driving characteristic is great, surface reflectivity of the phosphor is great, and color purity due to orange light emitted from helium (He), or xenon (Xe) used as a sealing gas is lower than the CRT. Accordingly, EM radiation and NI radiation generated in the PDP apparatus may have harmful effects on human bodies, and cause sensitive equipment such as wireless telephones, remote controls, and the like, to malfunction.

Therefore, in order to use the PDP apparatus, it is required to prevent emission of EM radiation and NI radiation emitted from the PDP apparatus from increasing to more than a predetermined level. PDP filters having functions such as an EM radiation-shielding function, an NI radiation-shielding function, a surface antiglare function, enhancement of color purity, and the like, are used for EM radiation-shielding and NI radiation-shielding while simultaneously reducing reflected light, and enhancing color purity.

The PDP filter may be manufactured such that functional films such as an EM radiation-shielding film, an NI radiation-shielding film, a neon light-shielding film, and the like are stacked one upon another using a glue or an adhesive agent. Here, the EM radiation-shielding film may be divided into a mesh type film using a metal mesh and a conductive layer type film using a conductive layer.

As to the EM radiation-shielding film of the mesh type, as examples for schemes for using the metal mesh, a scheme for weaving a fiber coated with a metal and a scheme for etching a thin copper foil may be designated. Here, the mesh film obtained by the etching scheme may be generally used.

The scheme for etching the thin copper foil may be performed by the following processes. First, a copper film may be formed by a plating scheme, and then surface treatments may be executed on the copper film such as a blackening treatment for improvement of image quality, a surface ruggedness treatment for improvement of adhesive force, an antioxidant treatment, and the like. Next, the copper foil may be adhered on a polyethylene terephthalate (PET) film using an adhesive agent. Next, a pattern may be formed on the adhered copper film using a lithography method, and the copper film with the pattern may be partially etched, thereby fabricating the mesh film.

However, the mesh film fabricated by the etching scheme may have problems such as a high processing cost for the etching itself, a high material cost caused due to having to remove 90% or more of the copper, and the like. Alternatively, in order to reduce the dissipation of the copper caused by the etching scheme, a seed layer for electroless plating may be formed by the lithography method, and the copper may be formed on the seed layer by a plating method. However, there still arise problems such as complexity in the process performed by the lithography method.

Additionally, the EM radiation-shielding film of the conductive layer type may be fabricated such that a metal layer and a transparent layer with a relatively high refractive index are stacked one upon another. In this instance, the metal layer may be preferably stacked three to six times for improving EM radiation-shielding efficiency. However, a process for stacking the metal layer in order to fabricate the EM radiation-shielding film of the conductive layer type may correspond to a thin film deposition process, which requires a significantly long time and results in reduction in a visible ray transmittance through all layers along with an increase in a number of times the process is repeated. Also, the manufacturing time and cost may increase along with an increase in a number of the metal layers.

Accordingly, in the EM radiation-shielding film of the conductive layer type, the thin film deposition process may be required to be effectively designed by reducing a number of times the metal layer is stacked, and as a result, there may be a need for developing a PDP filter adopting an optical member that performs an EM radiation-shielding function for simultaneously enhancing the visible ray transmittance and the EM radiation-shielding efficiency. Also, a need for developing a PDP filter for sufficiently performing the EM radiation-shielding function even when the EM radiation-shielding film is not included in the filter may further arise.

In this regard, attempts for reducing the manufacturing cost required for manufacturing the mesh type or the conductive layer type EM radiation-shielding films have been made. In addition, attempts for developing a multi-functional optical member, which can effectively complement the EM radiation-shielding function while reducing the relative importance of the existing EM radiation-shielding film within the PDP filter, have been made.

### SUMMARY OF THE INVENTION

An aspect of the present invention provides an optical member for a display apparatus which simultaneously performs an electromagnetic wave-shielding function and an external light-shielding function, and realizes an effective manufacturing process.

An aspect of the present invention provides a filter for a display apparatus having the optical member in which a number of times an electromagnetic wave-shielding film is stacked is less than that of a conventional electromagnetic wave-shielding film of the conductive layer type, or in which a conventional electromagnetic wave-shielding film is not included in the filter.

An aspect of the present invention provides a filter for a display apparatus in which an external light is effectively absorbed, a viewing angle is widened, brightness is improved, and a contrast ratio in a bright room is increased.

According to an aspect of the present invention, there is provided an optical member for a display apparatus, which includes: a transparent resin material; and a first optical pattern formed on a surface of the transparent resin material, and including a plurality of first shielding parts filled with a light absorbing substance and a conductive substance.

In this instance, the optical member may further include a second optical pattern formed on the first optical pattern, and including a plurality of second shielding parts crossing the first optical pattern and having a conductive substance.

Also, the optical member may further include an electrode disposed on at least a portion of an edge portion of the transparent resin material in such a manner as to cover an end of the second optical pattern.

Also, the first optical pattern may have a stripe shaped-pattern parallel to a side of the transparent resin material, and the second optical pattern may have a stripe shaped-pattern perpendicular to the first optical pattern. In this instance, each of the first shielding parts may have a wedge shape, a trapezoid shape, a U-shape, or a semicircular shape in its cross-sectional area.

Also, a width of the electrode may be about 10 to 50 mm. In this instance, the electrode may be disposed on a first edge portion adjacent to a side of the transparent resin material and a second edge portion adjacent to another side of the transparent resin material crossing the side of the transparent resin material. In this instance, the electrode may be disposed on the entire edge portion of the transparent resin material.

Also, each line width of the second shielding parts may be about 5 to 30 μm, each thickness thereof may be less than about 30 μm, and each interval therebetween may be about 0.3 to 100 mm.

Also, each of the first shielding parts may include an electromagnetic wave-shielding portion with a conductive substance and an external light-shielding portion with a light absorbing substance.

Also, each of the first shielding parts may include an external light-shielding portion in which a concentration of the light absorbing substance is greater than that of the conductive substance, and an electromagnetic wave-shielding portion in which a concentration of the conductive substance is greater than that of the light absorbing substance. Specifically, the external light-shielding portion may be formed on an upper portion of the first shielding part, and the electromagnetic wave-shielding portion may be formed on a lower portion thereof. Conversely, the electromagnetic wave-shielding part may be formed on the upper portion of the first shielding part, and the external light-shielding portion may be formed on the lower portion thereof.

In this instance, a volume ratio between the light absorbing substance and the conductive substance in the external light-shielding portion may be about 9:1 to 7:3. Also, a volume ratio between the light absorbing substance and the conductive substance in the electromagnetic wave-shielding portion may be about 1:9 to 3:7.

Also, the conductive substance included in the first shielding part and the second shielding part may be at least one substance selected from the group consisting of a carbon nanotube, a metal powder, and a metal oxide powder. In this instance, the conductive substance may include metal particles having a mean particle size of 10 μm or less.

In this instance, the metal powder may include a polymer resin and at least one metal selected from the group consisting of cobalt (Co), aluminum (Al), zinc (Zn), zirconium (Zr), platinum (Pt), gold (Au), palladium (Pd), titanium (Ti), iron (Fe), tin (Sn), indium (In), nickel (Ni), molybdenum (Mo), tungsten (W), silver (Ag), and copper (Cu). In this instance, the metal oxide powder may be at least one substance selected from the group consisting of a copper oxide, an aluminum oxide, a zinc oxide, an indium oxide, a tin oxide, an indium tin oxide (ITO), an aluminum zinc oxide, and an indium zinc oxide.

Also, the conductive substance may be at least one polymer substance selected from the group consisting of a polythiophene, a polyphenol, a polyaniline, a poly (3,4-ethylenedioxythiophene), a poly (3-alkylthiophene), a polyisothianaphthene (PITN), a poly (p-phenylenevinylene), a poly (p-phenylene), and a derivative thereof.

Also, the light absorbing substance included in the first shielding part may include a carbon black. In this instance, each of the first shielding parts includes: 10 to 40 wt % of a polymer resin, 1 to 10 wt % of the light absorbing substance, and 50 to 85 wt % of the conductive substance.

Also, the second shielding parts may be formed by screen-printing with a metal paste or by inkjet-coating with a metal paste. In this instance, the metal paste may include a polymer resin and at least one metal selected from the group consisting of cobalt (Co), aluminum (Al), zinc (Zn), zirconium (Zr), platinum (Pt), gold (Au), a palladium (Pd), titanium (Ti), iron (Fe), tin (Sn), indium (In), nickel (Ni), molybdenum (Mo), tungsten (W), silver (Ag), and copper (Cu). Also, the metal paste may include 10 to 30 wt % of the polymer resin, and 70 to 90 wt % of the metal as described above.

Also, the electrode may be formed using a metal paste, a metal tape, or a conductive polymer. In this instance, a copper foil tape may be used for the metal tape, and the conductive polymer may include at least one polymer substance selected from the group consisting of a polythiophene, a polyphenol, a polyaniline, a poly (3,4-ethylenedioxythiophene), a poly (3-alkylthiophene), a polyisothianaphthene (PITN), a poly (p-phenylenevinylene), a poly (p-phenylene), and a derivative thereof. In this instance, the metal paste comprising the electrode may include a polymer resin and at least one metal selected from the group consisting of cobalt (Co), aluminum (Al), zinc (Zn), zirconium (Zr), platinum (Pt), gold (Au), palladium (Pd), titanium (Ti), iron (Fe), tin (Sn), indium (In), nickel (Ni), molybdenum (Mo), tungsten (W), silver (Ag), and copper (Cu), which are the same substances as the second shielding parts.

A filter for a display apparatus according to an exemplary embodiment of the present invention may be formed such that a plurality of functional members are stacked one upon another. In this instance, any one of the functional members may include a transparent resin material, and a first optical pattern formed on a surface of the transparent resin material and including a plurality of first shielding parts filled with a light absorbing substance and a conductive substance.

Also, the filter for the display apparatus may include a transparent substrate, an optical member, a color correction layer, and an anti-reflection layer. In this instance, the optical member may be formed on a surface of the transparent substrate and include i) a transparent resin material, and ii) a first optical pattern formed on a surface of the transparent resin material and including a plurality of first shielding parts filled with a light absorbing substance and a conductive substance. The color correction layer may be formed on the optical member and contain at least one colorant for selectively absorbing a light. The anti-reflection layer may be formed on another surface of the transparent substrate.

Also, the first shielding part may include an external light-shielding portion with the light absorbing substance, and an electromagnetic wave-shielding portion with the conductive substance. In this instance, each of the first shielding parts may have a wedge shape, a trapezoid shape, a U-shape, or a semicircular shape in its cross-sectional area.

Also, the first shielding part may include an external light-shielding portion in which a concentration of the light absorbing substance is greater than that of the conductive substance, and an electromagnetic wave-shielding portion in which a concentration of the conductive substance is greater than that of the light absorbing substance.

A filter for a display apparatus according to another exemplary embodiment of the present invention may be formed such that a plurality of functional members are stacked one upon another. In this instance, any one of the functional members may include a transparent resin material, a first optical pattern formed on a surface of the transparent resin material and including a plurality of first shielding parts filled with a light absorbing substance and a conductive substance, and a second optical pattern formed on the first optical pattern, and including a plurality of second shielding parts crossing the first optical pattern and having a conductive substance.

In this instance, the first optical pattern may include a plurality of first shielding parts including an external light-shielding portion with a light absorbing substance and an electromagnetic wave-shielding portion with a conductive substance, respectively.

Also, the functional members may further include an electrode disposed on at least a portion of an edge portion of the transparent resin material in such a manner as to cover an end of the second optical pattern.

Here, as to the plurality of functional members, an electromagnetic wave-shielding function, a color correction function, an anti-reflection function, and the like may be independently performed, or combined functions thereof may be performed. In this instance, any one of the functional members may include at least one colorant for selectively absorbing a light. In this instance, the colorant may include at least one of a cyanine-based dye, an anthraquinone-based dye, a naphthoquinone-based dye, a phthalocyanine-based dye, a naphthalocyanine-based dye, a dimonium-based dye, a nikeldithiol-based dye, an azo-based dye, a styril-based dye, and a methine-based colorant dye.

The filter for the display apparatus according to another exemplary embodiment of the present invention may include a transparent substrate, an electromagnetic wave-shielding layer, an optical member, a color correction layer, and an anti-reflection layer. In this instance, the electromagnetic wave-shielding layer may include a conductive layer formed by alternatively stacking a metal thin film and a metal oxide thin film one to three times, and the optical member may include i) a transparent resin material, and ii) a first optical pattern formed on a surface of the transparent resin material and including an external light-shielding portion with a light absorbing substance and an electromagnetic wave-shielding portion with a conductive substance, respectively. Also, the color correction layer may be formed on the optical member and contain at least one colorant for selectively absorbing a light, and the anti-reflection layer may be formed on another surface of the transparent substrate.

In this instance, the optical member may further include a second optical pattern formed on the first optical pattern, and including a plurality of second shielding parts crossing the first optical pattern and having a conductive substance.

In this instance, the display apparatus according to the present invention may be effectively applicable to a PDP apparatus with lattice patterned pixels and can realize RGB (Red, Green, Blue), an Organic Light Emitting Diode (OLED) apparatus, a Liquid Crystal Display (LCD) apparatus, and a Field Emission Display (FED) apparatus, and the like. For convenience of descriptions, exemplary embodiments of the present invention will be hereinafter described in detail using a PDP apparatus and a PDP filter for the PDP apparatus, but the embodiments are not limited thereto. The present invention may be applied to various kinds of display apparatuses and the filters for the display apparatus as described above.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is an exploded perspective view illustrating a plasma display panel (PDP) apparatus according to an exemplary embodiment of the present invention;

FIG. 2A is a cross-sectional view illustrating a PDP filter according to an exemplary embodiment of the present invention;

FIG. 2B is a cross-sectional view illustrating a PDP filter according to another exemplary embodiment of the present invention;

FIG. 3 is a perspective view illustrating an optical member according to an exemplary embodiment of the present invention;

FIG. 4 is a perspective view illustrating an optical member according to another exemplary embodiment of the present invention;

FIG. 5 is a cross-sectional view illustrating an optical member according to another exemplary embodiment of the present invention; and

FIG. 6 is a cross-sectional view illustrating an optical member according to another exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

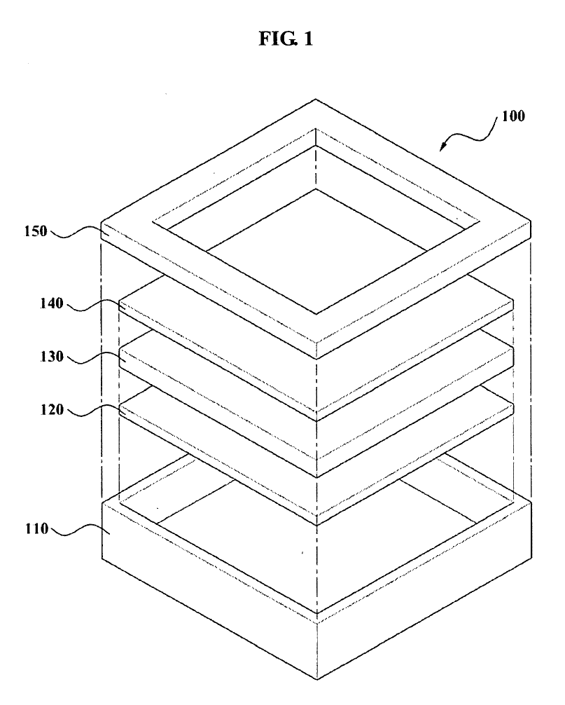

FIG. 1 is an exploded perspective view illustrating a plasma display panel (PDP) apparatus 100 according to an exemplary embodiment of the present invention.

Referring to FIG. 1, the PDP apparatus 100 of the present exemplary embodiment includes a case 110, a cover 150 covering an upper portion of the case 110, a driving circuit substrate 120, a panel assembly 130 including discharge cells where a gas discharge phenomenon occurs, and a PDP filter 140.

The PDP filter 140 is disposed over a front substrate of the panel assembly 130. The PDP filter 140 may be disposed apart from the front substrate of the panel assembly 130, or disposed to be close contact with the front substrate. Alternatively, in order to prevent adverse effects such as foreign substances entering between the panel assembly 130 and the PDP filter 140 or to reinforce the stiffness of the PDP filter 140 itself, the PDP filter 140 may be adhered to the front substrate of the panel assembly 130 using an adhesive agent or glue.

The PDP filter 140 is formed such that a conductive layer having superior conductivity is formed on the transparent substrate, and the conductive layer is grounded to the case 110 using the cover 150. Specifically, an electromagnetic wave generated from the panel assembly 130 is grounded to the cover 150 and the case 110 via the conductive layer of the PDP filter 140 before the electromagnetic wave reaches a user. Discharge gases are sealed in the discharge cells, and as examples for the discharge gas, Ne—Xe based gas, He—Xe based gas, and the like may be designated. The panel assembly basically has the same light emitting principle as a fluorescent lamp, such that an ultraviolet (UV) generated from the discharge gases by a discharge generated within light emitting cells is emitted and excites a phosphor to thereby be converted into a visible ray.

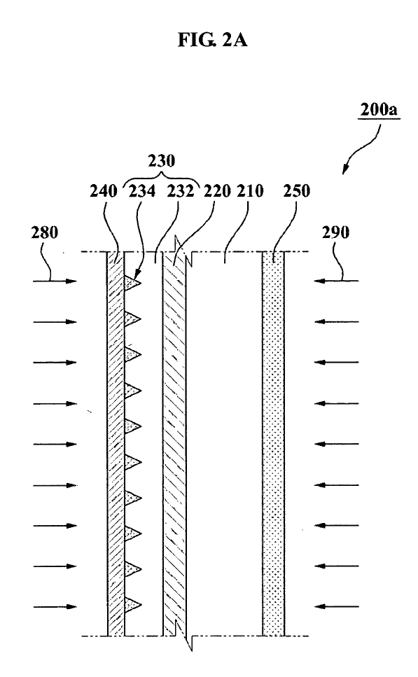

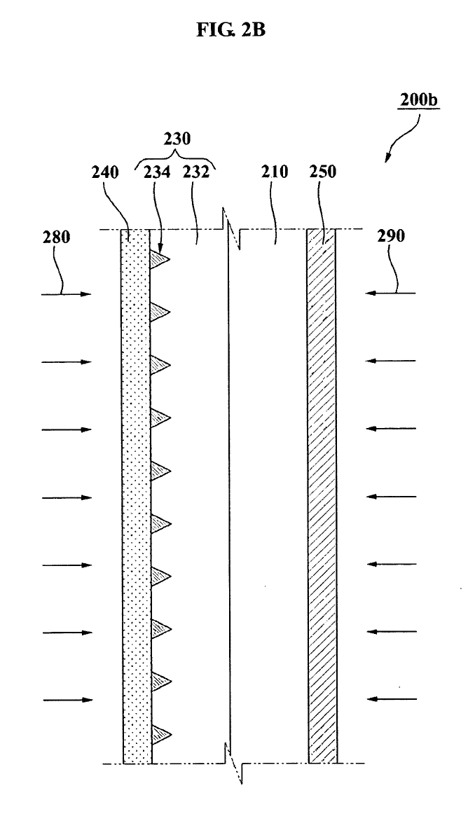

FIG. 2A is a cross-sectional view illustrating a PDP filter 200a according to an exemplary embodiment of the present invention.

Referring to FIG. 2A, the PDP filter 200a includes a transparent substrate 210, and optical members having various shielding functions such as an electromagnetic wave-shielding layer 220, an optical member 230, a color correction layer 240, and an anti-reflection layer 250.

With respect to the transparent substrate 210, the electromagnetic wave-shielding layer 220, the optical member 230, and the color correction layer 240 are disposed in a panel assembly side in such a manner as to be formed on a surface of the transparent substrate 210, that is, a surface facing the panel assembly, and the anti-reflection layer 250 is disposed in a side, in which an external light 290 enters, in such a manner as to be formed on another surface of the transparent substrate 210, that is, opposite to the surface of the transparent substrate 210. However, embodiments of the present invention are not limited thereto, and the transparent substrate 210, the electromagnetic wave-shielding layer 220, the optical member 230, the color correction layer 240, and the anti-reflection layer 250 may be stacked one upon another regardless of the stated order. In this instance, a single optical member may perform at least two functions.

The transparent substrate 210 may be formed of transparent inorganic compound molded articles such as glass, quartz, and the like, and transparent organic polymeric molded articles. As examples for the transparent organic polymeric molded articles, an acryl and a polycarbonate may be designated, but embodiments of the present invention are not limited thereto. The transparent substrate 210 preferably has high transparency and heat resistance, and a polymeric molded article or a lamination thereof may be used for the transparent substrate 210. As to the transparency and the heat resistance of the transparent substrate, a visible ray transmittance is preferably 80% or more, and a glass transition temperature is preferably 50° C. or more. As to the polymeric molded article, the transparency should be ensured in a visible ray wavelength region, and a polyethylene terephthalate (PET) is preferably used for the polymeric molded article in view of the price, heat resistance, and transparency, but embodiments of the present invention are not limited thereto. Also, the transparent substrate 210 may be excluded from a configuration of the filter, as necessary.

The anti-reflection layer 250 functions to prevent the external light 290 entering from a viewer side from being reflected to the outside, and improve a contrast ratio of a display apparatus. The anti-reflection layer 250 according to the present exemplary embodiment is formed on a surface of the transparent substrate 210 opposite to the surface on which the electromagnetic wave-shielding layer 220 is stacked, however embodiments of the present invention are not limited thereto.

Preferably, as shown in FIG. 2A, the anti-reflection layer 250 may be formed in a viewer side opposite to a side in which the panel assembly is positioned when the PDP filter 200a is equipped to the PDP apparatus.

The electromagnetic wave-shielding layer 220 functions to block an electromagnetic wave generated from the panel assembly. For this purpose, a conductive material having a relatively high conductivity is required to be covered on an outer surface of the display apparatus. A conductive mesh film or a multi-layered transparent conductive film which is laminated with a metal thin film and a transparent thin film with a relatively high refractive index may be used for the electromagnetic wave-shielding layer 120. Here, as examples for the conductive mesh film, a grounded metal mesh, or a mesh of a synthetic resin or metal fiber coated with a metal may be designated. As examples for substances of a metal used for the conductive mesh film, substances having superior electric conductivity and workability such as copper (Cu), chrome (Cr), nickel (Ni), silver (Ag), molybdenum (Mo), tungsten (W), aluminum (Al), and the like may be designated.

Also, a transparent thin film having a high refractive index, which represents an Indium Tin Oxide (ITO), may be used for the multi-layered transparent conductive film for the purpose of blocking the electromagnetic wave. A multi-layered thin film obtained by alternatively laminating a metal thin film made of substances such as gold (Au), silver (Ag), copper (Cu), platinum (Pt), palladium (Pd), and the like, and a transparent thin film with a high refractive index made of substances such as an indium oxide, stannic oxide, a zinc oxide, and the like may be used for the multi-layered transparent conductive film.

Although not shown in FIG. 2A, the PDP filter 200a according to the present exemplary embodiment may separately include a near-infrared (NIR) shielding layer. The NIR shielding layer functions to block a strong NIR causing electric equipment such as a wireless telephone, a remote control, and the like, to malfunction.

The multi-layered transparent conductive film used for the electromagnetic wave-shielding layer 220 according to the present exemplary embodiment serves to block the NIR. Accordingly, in this case, the electromagnetic wave-shielding layer 220 alone acts to simultaneously perform the NIR and electromagnetic wave shielding functions without separately forming the NIR shielding layer. Of course, depending on embodiments, the NIR-shielding layer may be separately formed.

The PDP filter 200a includes the color correction layer 240 for selectively absorbing a light t in a specific wavelength range. The color correction layer 240 is disposed in a side of the panel assembly, in particular, formed on a surface of the optical member 230, however embodiments of the present invention are not limited thereto. The color correction layer 240 may reduce or adjust each amount of red (R), green (G), and blue (B), so that a color balance is changed or corrected, thereby increasing a color gamut of the display apparatus, and improving color definition.

The color correction layer 240 includes various colorants for which a dye or a pigment may be used. Here, organic colorants having a Ne-Cut function such as an anthraquinone-based dye, a cyanine-based dye, an azo-based dye, a styril-based dye, a phthalocyanine-based dye, a methine-based colorant dye, and the like may be used for the colorants, but embodiments of the present invention are not limited thereto. A kind and concentration of the colorant may be determined depending upon an absorption wavelength and absorption coefficient of the colorant, and transmission characteristics which are required for the display apparatus, and thus they are not limited by specific numerical values.

Also, although not shown in FIG. 2A, the PDP filter 200a may further include a diffusion layer. The diffusion layer functions to prevent a moiré phenomenon or a Newton ring phenomenon from occurring due to an interference phenomenon of an incident light and a reflected light when periodic patterns shown in the optical member 230 and the electromagnetic wave-shielding layer 220 are reflected on a front surface of the panel assembly. The diffusion layer may be placed in an arbitrary position within the PDP filter 200a, however, is preferably placed on a surface of the PDP filter 200a adjacent to the panel assembly. In this instance, the diffusion layer may be included in the PDP filter 200a while serving as a separate layer, however, a combination with other optical members may be also possible.

The optical member 230 includes a transparent resin material 232, and an optical pattern 234 with a plurality of wedge-shaped shielding parts formed on a surface of the transparent resin material 232. The optical pattern 234 is formed into a wedge-shape in its cross-sectional area. Specifically, the optical pattern 234 is formed such that the surface of the transparent resin material 232 is engraved to be shaped in a three-dimensional triangular pyramid, but embodiments of the present invention are not limited thereto. Thus, the optical pattern 234 may be formed into an intaglio or emboss shape with a two or three dimension.

The optical member 230 is disposed in a side opposite to the side in which the anti-reflection layer 250 is disposed with respect to the transparent substrate 210, but embodiments of the present invention are not limited thereto. Thus, a stacked order or stacked direction between the optical members may vary as long as the optical member 230 is disposed in such a manner that good absorption of the external light 290 and good transmission of an incident light 280 emitted from the panel assembly are obtained.

As to the optical pattern 234 according to the present exemplary embodiment, a bottom surface of a wedge-shaped unit pattern of the optical pattern 234, which is parallel to the surface of the transparent resin material, faces the panel assembly, but embodiments of the present invention are not limited thereto. Specifically, the bottom surface of the wedge-shaped unit pattern of the optical pattern 234 may be formed on another surface of the transparent resin material 232 in such a manner as to face the viewer side, or may be formed on both surfaces of the transparent resin material 232 in such a manner as to face the viewer side and the panel assembly, respectively.

The transparent resin material 232 is a flat plate-shaped supporter made of a transparent substance which enables a visible ray to be transmitted therethrough, and may include a polyethylene terephthalate (PET), an acryl, a polycarbonate (PC), a urethane acrylate, a polyester, an epoxy acrylate, a brominates acrylate, a polyvinyl chloride (PVC), and the like.

The optical member 230 functions to absorb the external light 290 to thereby prevent the external light 290 from entering the panel assembly, and also functions to total-reflect the incident light 280 emitted from of the panel assembly to the viewer side. As a result, a high transmittance with respect to the visible ray and a high contrast ratio can be obtained. In addition, the optical member 230 of the present exemplary embodiment simultaneously includes an external light-shielding portion filled with a light absorbing substance and an electromagnetic wave-shielding portion filled with a conductive substance, thereby performing the electromagnetic wave-shielding function.

In the case of using the optical member 230, since the electromagnetic wave-shielding layer 220 is formed between the optical member 230 and the transparent substrate 210, and the optical member 230 performs the electromagnetic wave-shielding function, the electromagnetic wave-shielding layer 220, whose surface resistance is less than 0.8Ω/□, may be used. In this instance, the electromagnetic wave-shielding layer 220 is a conductive layer acquired by stacking a metal thin film and a metal oxide thin film one to three times. Specifically, even when the thin films are stacked less than three to six times, that is, a typical number of times the thin films are stacked, the external light-shielding function of the PDP filter 200a may be satisfactorily performed.

According to the present exemplary embodiment, optical members having the electromagnetic shielding function, the anti-reflection function, and the color correction function, respectively, are separately described, but embodiments of the present invention are not limited thereto. In particular, the optical member 230 of the present exemplary embodiment includes the light absorbing substance and the conductive substance to thereby simultaneously perform the electromagnetic wave-shielding function and the external light-shielding function, and also functions to complement or reinforce the function of the electromagnetic wave-shielding layer 220. In addition, the optical member 230 may be substituted for the electromagnetic wave-shielding layer 220, when the PDP filter 200a does not include the electromagnetic wave-shielding layer.

FIG. 2B is a cross-sectional view illustrating a PDP filter 200b according to another exemplary embodiment of the present invention.

Referring to FIG. 2B, the PDP filter 200b includes a transparent substrate 210, and optical members having various shielding functions such as a multi-functional optical member 230 for simultaneously performing the electromagnetic wave-shielding function and the external light-shielding function, a color correction layer 240, and an anti-reflection layer 250.

With respect to the transparent substrate 210, the optical member 230 and the color correction layer 240 are disposed in a panel assembly side in such a manner as to be formed on a surface of the transparent substrate 210, that is, a surface facing the panel assembly, and the anti-reflection layer 250 is disposed in a side, in which an external light 290 enters, in such a manner as to be formed on another surface of the transparent substrate 210, that is, opposite to the surface of the transparent substrate 210.

However, embodiments of the present invention are not limited thereto, and the transparent substrate 210, the optical member 230, the color correction layer 240, and the anti-reflection layer 250 may be stacked one upon another regardless of the stated order. In this instance, a single optical member may perform at least two functions. Here, the PDP filter 200b of the present exemplary embodiment is configured in the same fashion as the PDP filter 200a except that the electromagnetic wave-shielding layer is excluded from the PDP filter 200b.

Detailed descriptions with respect to the transparent substrate 210, the optical member 230, the color correction layer 240, and the anti-reflection layer 250 will be the same as those illustrated in FIG. 2A, and will be omitted.

The optical member 230 according to the present exemplary embodiment includes a first optical pattern 234 and a second optical pattern. In this instance, the first optical pattern 234 is simultaneously filled with a light absorbing substance and a conductive substance, and the second optical pattern is also filled with a conductive substance, and therefore the optical member 230 simultaneously performs the external light-shielding function and the electromagnetic wave-shielding function. Accordingly, the optical member 230 may be substituted for the existing mesh type or conductive layer type electromagnetic wave-shielding layer, when the PDP filter 200b of the present exemplary embodiment does not include the electromagnetic wave-shielding layer.

Hereinafter, an optical member for a display apparatus according to the present invention will be described in detail, and the repeated descriptions thereof will be omitted.

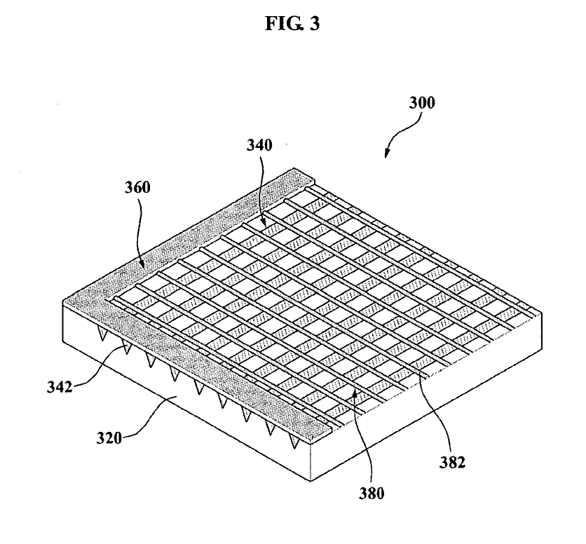

FIG. 3 is a perspective view illustrating an optical member 300 according to an exemplary embodiment of the present invention.

Referring to FIG. 3, the optical member 300 of the present exemplary embodiment includes a first optical pattern 340 including a plurality of first shielding parts 342, and a second optical pattern 380 including a plurality of second shielding parts 382, and an electrode 360.

The optical member 300 is formed such that an intaglio pattern having a predetermined shape is formed on a surface of a transparent resin material 320, and the inside of the intaglio pattern is filled with a resin including a light absorbing substance and a conductive substance, and then the filled resin is hardened, thereby forming the first optical pattern, 340. In this instance, each of the first shielding parts 342 corresponds to a unit of the first optical member 340.

As examples for general methods to form a pattern, a heat press method for pressing a heated mold on a thermoplastic resin, a casting method for injecting a thermoplastic resin composition into a mold and hardening the injected thermoplastic resin composition, an injection molding method, a ultraviolet (UV) method for injecting a UV curable resin composition into a mold and hardening the UV curable resin composition, and the like may be designated. Preferably, the optical member 300 is formed on a surface of the transparent resin material opposite to a surface on which the anti-reflection layer is formed, and a UV curable resin is used for the optical member 300 for the purpose of protection of the anti-reflection layer.

The first optical pattern 340 may vary depending on a shape of a mold, and may be generally formed into a wedge shape. The first optical pattern 340 of the transparent resin material is filled with a resin including a colored particle such as a carbon black and the like, and a conductive substance using a whipping scheme, and then the filled resin is hardened.

The second optical pattern 380 is formed such that the plurality of second shielding parts 382 are disposed with a predetermined interval therebetween in such a manner as to be orthogonal to the first optical pattern 340 after the first optical pattern 340 is formed. However, embodiments of the present invention are not limited thereto, the second optical pattern 380 may be formed to be slanted with respect to the first optical pattern 340 by a predetermined angle therebetween.

The second optical pattern 380 includes the plurality of second shielding parts 382 formed on the first optical pattern 340 with a predetermined pattern by inkjet-coating and screen-printing schemes performed using a metal paste.

Each line width of the second shielding parts 382 is about 5 to 30 μm, and each thickness thereof is less than about 30 μm. The line width of the second shielding parts 382 designates a width formed in a direction parallel to a side of the transparent resin material 320, that is, a direction parallel to a stripe-shaped arrangement of the first optical pattern 340, and the thickness thereof designates a thickness obtained in a direction orthogonal to the side of the transparent resin material 320. When the line width of the second shielding parts 382 is less than 5 μm, the area of the second shielding parts 382 contacting the first optical pattern 340 becomes insufficient, and thus relatively poor EM shielding effect may be expected. Also, when the line width or thickness of the second shielding parts 382 is greater than 30 μm, an entire area or thickness covering the first optical pattern 340 becomes greater, and thus relatively poor external light-shielding effect may be expected. As a result, an EM shielding efficiency is not increased while the manufacturing cost increases, compared with a case where the line width thereof is less than 30 μm.

Each interval between the second shielding parts 382 is about 0.3 to 100 mm. The second shielding parts 382 are preferably disposed to be spaced apart from one other by a predetermined interval, however, may be disposed with uneven intervals within the range of about 0.3 to 100 mm.

Hereinafter, substances composing the first optical pattern 340 and the second optical pattern 380 will be described in detail.

The first shielding parts 342 composing the first optical pattern 340 are filled with a light absorbing substance and a conductive substance, and the second shielding parts 382 composing the second optical pattern 380 includes the conductive substance.

An inside of the first shielding parts 342 is simultaneously filled with the light absorbing substance and conductive substance. In this instance, the light absorbing substance and the conductive substance may be separately dispersed or only the single type of conductive light absorbing substance may be dispersed. As to a weight ratio between the light absorbing substance and the conductive substance, when a weight ratio of the light absorbing substance to the conductive substance is less than 1%, the light absorbing capability is relatively deteriorated to thereby fail to effectively absorb the external light, which results in failing to improve a contrast in a bright room. When the weight ratio thereof is greater than 20%, a volume ratio of the light absorbing substance becomes larger to thereby relatively reduce an amount of the conductive substance per a unit volume. As a result, the light absorbing substance filled between the conductive substances reduces an inherent electrical conductivity of the conductive substance, thereby decreasing the EM shielding efficiency. Thus, the weight ratio of the light absorbing substance to the conductive substance may be about 1 to 20%, preferably about 1 to 12%, and more preferably about 2 to 5%.

The conductive substance includes metal particles having a mean particle size of about 15 μm or less. A filling operation becomes easy when reducing the mean particle size due to a general width of the first shielding parts 342 of about 20 to 32 μm.

Each of the first shielding parts 342 includes 10 to 40 wt % of a polymer resin, 1 to 10 wt % of the light absorbing substance, and 50 to 85 wt % of the conductive substance. The UV curable resin or the thermoplastic resin may be used for the polymer resin, and an acrylic-based resin such as a polymethyl methacrylate (PMMA) may be designated for an example for the polymer resin. Also, the polymer resin may be used separately or in a mixed form of the polymer resin and a solvent. Also, the polymer resin may further include an additive. In this instance, the additive acts as a dispersing agent enabling the conductive substance and the light absorbing substance to be stably dispersed within the solvent. As examples for the additive, an organic acidic-based substance with a carboxyl group such as a citric acid (CA) may be designated, and also a polyacrylic acid (PAA), a polyacrylate, a copolymer of PAA, and the like may be designated. The dispersing agent may be used separately or used in a combination of at least two.

A carbon-based substance such as a carbon black may be used for the light absorbing substance filled in the inside of the first shielding parts 342, and a black inorganic or organic substance may be designated for the light absorbing substance.

The conductive substance included in the first shielding parts 342 and the second shielding parts 382 may be at least one substance selected from the group consisting of a carbon nanotube, a metal powder, and a metal oxide powder.

In this instance, the metal powder may include at least one metal selected from the group consisting of cobalt (Co), aluminum (Al), zinc (Zn), zirconium (Zr), platinum (Pt), gold (Au), palladium (Pd), titanium (Ti), iron (Fe), tin (Sn), indium (In), nickel (Ni), molybdenum (Mo), tungsten (W), silver (Ag), and copper (Cu). Among these, Ag is preferably used due to its superior conductivity, infrared ray reflectivity, and visible ray transparency, however, may be deteriorated by pollutants, steam, heat, light, and the like in the peripheral environment due to its poor chemical and physical stability. Thus, an alloy of Ag and at least one metal of relatively stable metals with respect to the peripheral environment such as Au, Pt, Pd, Cu, In, Sn, and the like may be preferably used.

The metal oxide may be at least one substance selected from the group consisting of a copper oxide, an aluminum oxide, a zinc oxide, an indium oxide, a tin oxide, an indium tin oxide (ITO), an aluminum zinc oxide, and an indium zinc oxide. The metal oxide simultaneously satisfies the transparency and electric conductivity.

Also, the conductive substance may be at least one polymer substance selected from the group consisting of a polythiophene, a polyphenol, a polyaniline, a poly (3,4-ethylenedioxythiophene), a poly (3-alkylthiophene), a polyisothianaphthene (PITN), a poly (p-phenylenevinylene), a poly (p-phenylene), and a derivative thereof.

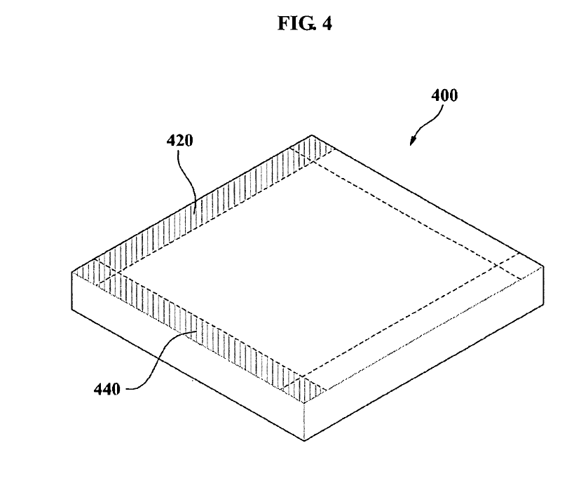

FIG. 4 is a perspective view illustrating an optical member according to another exemplary embodiment of the present invention. Hereinafter, an electrode of the optical member will be described in detail with reference to FIGS. 3 and 4.

Referring to FIG. 4, a transparent resin material 400 obtained before the first optical pattern, a second optical pattern, and the electrode are formed on the transparent resin material 400 is illustrated, and an edge portion of the transparent resin material 400 is illustrated with oblique lines. The edge portion includes a first edge portion 420 adjacent to a side of the transparent resin material 400, and a second edge portion 440 adjacent to another side of the transparent resin material 400 being orthogonal to the side of the transparent resin material 400.

The electrode is disposed in the first edge portion 420 and the second edge portion 440, however, embodiments of the present invention are not limited thereto. The electrode may be disposed on the entire edge portion of the transparent resin material 400, or may be disposed in two facing edge portions, whereby the electrode is formed parallel to the first optical pattern 340 and the second optical pattern 380.

A width of the electrode may be determined such that the electrode is connected with the conductive substance within the first shielding parts 342 and the second shielding parts 382 to thereby serve as a grounding element, which results in having a width of about 10 to 50 mm.

The electrode 360 may be formed of a substance having a high electric conductivity such as a metal paste, a metal tape, or a conductive polymer. The electrode 360 serving as a grounding element for the display apparatus may be formed in an edge portion of the optical member 300 using a printing scheme utilizing a mask, a conductive copper foil-lamination scheme, and the like.

The metal paste may include a polymer resin and at least one metal selected from the group consisting of Co, Al, Zn, Zr, Pt, Au, Pd, Ti, Fe, Sn, In, Ni, Mo, W, Ag, and Cu. Also, the metal paste may include 10 to 30 wt % of the polymer resin, and 70 to 90 wt % of the metal as described above. The thermosetting resin, the thermoplastic resin, or the UV curable resin may be used for the polymer resin. The polymer resins such as an epoxy resin, a phenolic resin, a polyester resin, a polyimide resin, an acrylic resin, and the like may be used separately or mixed, however, embodiments of the present invention are not limited thereto. The polymer resin included in the metal paste may be used separately or in a mixed form of the polymer resin and an additive or a solvent.

The metal tape may be a copper foil tape, and the conductive polymer substance may be at least one polymer substance selected from the group consisting of a polythiophene, a polyphenol, a polyaniline, a poly (3,4-ethylenedioxythiophene), a poly (3-alkylthiophene), a polyisothianaphthene (PITN), a poly (p-phenylenevinylene), a poly (p-phenylene), and a derivative thereof.

As to substances consisting of the electrode as described above, substances having superior electric conductivity, superior processing properties, and being easily formed may be used for the electrode of the optical member. In particular, the metal paste is preferably used for the electrode so that an electrical connection with the conductive substance filled in the pattern is effectively performed. Specifically, a silver paste, a copper paste, a silver-carbon paste, and the like may be used for the metal paste.

Also, the electrode 360 and the second optical pattern 380 may be simultaneously formed of the same conductive substance in a single process. For example, the electrode 360 and the second optical pattern 380 may be formed by screen-printing with a metal paste or by inkjet-coating with a metal paste.

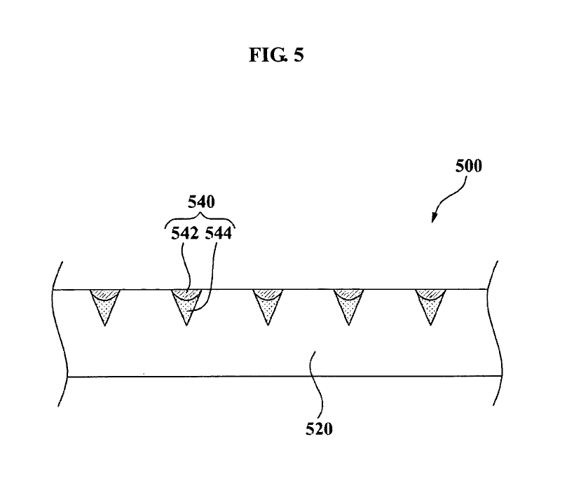

FIG. 5 is a cross-sectional view illustrating an optical member 500 according to another exemplary embodiment of the present invention.

Referring to FIG. 5, the optical member 500 includes a transparent resin material 520, and a plurality of first shielding parts 540 including an external light-shielding portion 542 and an electromagnetic wave-shielding portion 544. In this instance, each of the first shielding parts 540 is formed into a wedge shape in its cross-sectional area, however, embodiment of the present invention are not limited thereto. Thus, each of the first shielding parts 540 may be formed into a trapezoid shape, a U-shape, or a semicircular shape in its cross-sectional area.

The optical member 500 is manufactured such that an intaglio pattern having a predetermined shape is formed on a surface of the transparent resin material 520, a resin containing a conductive substance is filled in the intaglio pattern to thereby form the electromagnetic wave shielding portion 544, a resin containing a light absorbing substance is further filled in the intaglio pattern in such a manner as to cover on the electromagnetic wave-shielding portion 544 to thereby form the external light-shielding portion 542, and then the filled resins are hardened.

As examples for general methods to form the pattern, a heat press method for pressing a heated mold on a thermoplastic resin, a casting method for injecting a thermoplastic resin composition into a mold and hardening the injected thermoplastic resin composition, an injection molding method, a ultraviolet (UV) method for injecting a UV curable resin composition into a mold and hardening the UV curable resin composition, and the like may be designated. The pattern may vary depending on a shape of a mold, and may be generally formed into a wedge shape. The pattern formed on the transparent resin material is filled with a resin containing colored particles such as a carbon black and the like and a conductive substance using the wiping scheme, and then the filled resin is hardened.

The external light-shielding portion 542 and the electromagnetic wave-shielding portion 544 within the first shielding parts 540 are distinguished in two parts, however, embodiments of the present invention are not limited thereto. Thus, the external light-shielding portion 542 and the electromagnetic wave-shielding portion 544 may be distinguished in more than two parts.

A carbon-based substance such as a carbon black may be used for the light absorbing substance filled in the external light-shielding portion 542, and a black inorganic or organic substance may be designated for the light absorbing substance.

The conductive substance filled in the electromagnetic wave-shielding portion 544 has a mean particle size of 15 μm or less. A filling operation becomes easy when reducing the mean particle size due to a general width of a bottom surface of the first shielding parts 540 of about 20 to 32 μm. In this instance, the bottom surface of the first shielding parts 540 is exposed to the outside of the transparent resin material 520.

The conductive substance may be at least one substance selected from the group consisting of a carbon nanotube, a metal powder, and a metal oxide powder, and the specific examples are the same as described above.

The thermosetting resin, or the UV curable resin may be used for the polymer resin filled in the first shielding parts 540, and an acrylic-based resin such as a polymethyl methacrylate (P may be designated for an example of the polymer resin. Also, the polymer resin may be used separately or in a mixed form of the polymer resin and an additive or a solvent. In this instance, the additive acts as a dispersing agent enabling the conductive substance and the light absorbing substance to be stably dispersed within the solvent.

As examples for the additive, an organic acidic-based substance with a carboxyl group such as a citric acid (CA) may be designated, and also a polyacrylic acid (PAA), a polyacrylate, a copolymer of PAA, and the like may be designated. The dispersing agent may be used separately or used in a combination of at least two.

The external light-shielding portion 542 includes the polymer resin and the light absorbing substance, however, may include a part of the conductive substance. Specifically, a volume ratio between the light absorbing substance and the conductive substance in the external light-shielding portion 542 may be about 9:1 to 7:3. In this case, the external light-shielding portion 542 mainly shields the external light, and additionally shields the electromagnetic wave by being electrically connected with the electromagnetic wave-shielding portion 544 positioned in a lower portion of each of the first shielding parts 540.

Similarly, the electromagnetic wave-shielding portion 544 includes the polymer resin and the conductive substance, however, may include a part of the light absorbing substance. Specifically, a volume ratio between the light absorbing substance and the conductive substance in the electromagnetic wave-shielding portion 544 may be about 1:9 to 3:7. In this case, the electromagnetic wave-shielding portion 544 mainly shields the electromagnetic-wave, and additionally shields the external light.

Also, the present invention may include a case where each concentration of the light absorbing substance and the conductive substance, filled within the external light-shielding portion 542 and the electromagnetic wave-shielding portion 544, is uniform, as well as a case where each concentration thereof is uneven or differs in a stepwise fashion.

As to the optical member 500, the electrode may be formed in both ends of the optical pattern including the first shielding parts 540 using the conductive substance, thereby improving the electromagnetic wave-shielding efficiency.

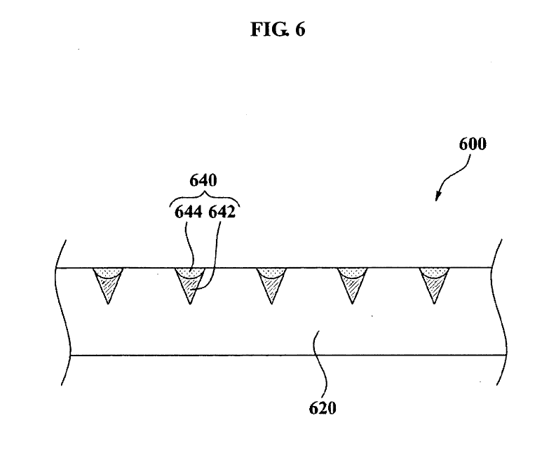

FIG. 6 is a cross-sectional view illustrating an optical member 600 according to another exemplary embodiment of the present invention. As to the optical member 600 of the present exemplary embodiment, the repeated descriptions will be herein omitted.

Referring to FIG. 6, the optical member 600 includes a transparent resin material 620, and a plurality of first shielding parts 640 including an external light-shielding portion 642 and an electromagnetic wave-shielding portion 644. The optical member 600 is manufactured such that an intaglio pattern having a predetermined shape is formed on a surface of the transparent resin material 620, a resin containing the light absorbing substance is filled in the intaglio pattern to thereby form the external light-shielding portion 642, a resin containing the conductive substance is further filled in the intaglio pattern in such a manner as to cover over the external light-shielding portion 642 to thereby form the electromagnetic wave-shielding portion 644, and then the filled resins are hardened.

As illustrated in FIG. 6, in the cases where the electromagnetic wave-shielding portion 644 is positioned on the external light-shielding portion 642 within the first shielding part 640, and where the electromagnetic wave-shielding portion 544 is positioned beneath the external light-shielding portion 542 within the first shielding part 540, similar electromagnetic wave-shielding and external light-shielding effects may be achieved. Accordingly, the electromagnetic wave-shielding and external light shielding efficiencies of the optical members 500 and 600 are free from the influence of the stacked order between the external light-shielding portions 542 and 642, and the electromagnetic wave-shielding portions 544 and 644 within the first shielding parts 540 and 640. However, a surface resistance value of the optical members 500 and 600 decreases along with an increase in an entire amount of the conductive substance filled in the first shielding parts 540 and 640, thereby enhancing the electromagnetic wave-shielding efficiency.

Thus, in order to optimize the external light-shielding efficiency and the electromagnetic wave-shielding efficiency of the optical member according to the present exemplary embodiment, a relative volume ratio between the external light-shielding portion and the electromagnetic wave-shielding portion within the first shielding parts may be adjusted, and each amount of the light absorbing substance filled in the external light-shielding portion and the conductive substance filled in the electromagnetic wave-shielding portion, respectively, may be also adjusted.

Hereinafter, the following Examples and Comparison Examples will illustrate a manufacturing method of the optical member according to the present invention, in detail, but the present invention is not limited thereto.

### Example 1

An additive, solvent, and a polymer resin mixture mixed with a polymer resin were prepared. A poly acrylic acid, a toluene, and a polymethyl methacrylate were used for the additive, the solvent, and the polymer resin, respectively. Next, a conductive paste acquired by dispersing a ball-shaped Ag powder, a carbon black, and the polymer resin were mixed in such a manner as to have a weight percent (wt %) of 70:2:28, respectively, was filled in a stripe-shaped first optical pattern, which was formed into a trapezoid shape in its cross-sectional area and arranged by a predetermined interval therebetween, thereby fabricating a conductive light absorbing film.

Next, a second optical pattern was formed on the conductive light absorbing film with an Ag paste using a screen printer. In this instance, the second optical pattern was formed to be orthogonal to the first optical pattern, and had a line width of the second optical pattern of about 30 μm, a thickness thereof of about 10 μm, and a pitch thereof of about 500 μm. Subsequently, the formed first optical pattern and the second optical pattern were dried for five minutes in a drying furnace heated to about 120° C., thereby completing the conductive light absorbing film. Next, an electrode was formed in the four edge portions of the completed film using the Ag paste in such a manner as to have a width of about 10 mm, thereby completing an optical member.

### Example 2

A conductive light absorbing film was manufactured in the same process as Example 1 except that the line width of the second optical pattern, the thickness thereof, and the pitch thereof were 30 μm, 10 μm, and 10 mm, respectively. Next, an electrode was formed in four edge portions of the manufactured film using an Ag paste in such a manner as to have a width of about 10 mm, thereby completing an optical member.

### Comparative Example 1

A conductive light absorbing film including a first optical pattern formed thereon was manufactured in the same process as Example 1 except that a second optical pattern was not formed on the film. Next, an electrode was formed in four edge portions of the manufactured film using an Ag paste in such a manner as to have a width of about 10 mm, thereby completing an optical member.

Each of the optical members manufactured in Examples 1 and 2, and Comparative Example 1 was stacked on a surface of a glass substrate with a thickness of 3.0 mm using an adhesive agent, a color correction film was stacked on the stacked optical member, and an anti-reflection film was stacked on another surface of the glass substrate, which is opposite to the surface thereof, thereby manufacturing a PDP filter.

An electromagnetic wave-shielding rate of PDP filters manufactured using the optical members of Examples 1 and 2, and Comparative Example 1 was measured, respectively. A test for measuring the electromagnetic wave-shielding rate in a state where each of the PDP filters was mounted to a panel assembly was performed according Class B devices in a shield room that meets American National Standards Institute (ANSI) C63.4 1992, that is, an electromagnetic wave measurement facility standard.

Next, in order to measure an external light absorption efficiency of the optical member, an external light was artificially prepared, the PDP filter was mounted to the panel assembly, and then a frontward illumination intensity for a screen of the PDP was adjusted by about 150 lux. The screen of the PDP in the state where the PDP filter was mounted to the panel assembly was displayed as an entire black image, and then an amount of reflection of the external light was measured in a wavelength range of about 380 nm to 780 mm using a luminance meter.

The measured results of the electromagnetic wave shielding rate and the amount of reflection of the external light were shown in the following Table 1.

TABLE 1

| | | | Comparative |
|---|---|---|---|
| | Example 1 | Example 2 | Example 1 |
| Electromagnetic | Acceptable | Acceptable | Unacceptable |
| wave-shielding rate | | | |
| Class B standard | | | |
| Amount of | 1.95 | 1.98 | 2.1 |
| reflection of | | | |
| External light | | | |
| (cd/m²) | | | |

In the case of the PDP filter adopting the conductive light absorbing film, which includes the first optical pattern filled with the light absorbing substance and the conductive substance and the second optical pattern being orthogonal to the first optical pattern, as illustrated in Examples 1 and 2, and superior electromagnetic wave-shielding efficiency was shown and the amount of reflection of the external light was reduced so that a contrast ratio in a bright room was improved in an equivalent or relatively larger fashion, compared with the optical member acquired in Comparative Example 1.

The optical member for the display apparatus according to the present invention simultaneously performs the electromagnetic wave-shielding function and the external light function while serving as a single member, although a separate electromagnetic wave shielding layer is not disposed within the filter for the display apparatus.

As described above, according to the present invention, there is provided an optical member for a display apparatus which can simultaneously perform a electromagnetic wave-shielding function and an external light function. In particular, since the electromagnetic wave-shielding layer is not formed within the filter for the display apparatus, the manufacturing process is simplified, and the manufacturing cost is reduced. Also, even when the electromagnetic wave-shielding layer is used, a number of times the thin film is stacked is reduced in the electromagnetic wave-shielding layer of the conductive layer type, thereby reducing the manufacturing cost of the filter for the display apparatus, and simplifying the manufacturing process.

According to the present invention, there is provided an optical member for a display apparatus which can effectively absorb the external light, widen the viewing angle, and concentrate internal light of the display apparatus, thereby improving the brightness of the display apparatus, and enhancing the contrast in a bright room.

According to the present invention, there is provided the optical member for the display apparatus, which effectively performs multi-functions such as an external light-shielding function, an electromagnetic wave-shielding function, and the like, thereby simplifying the manufacturing process, and reducing the manufacturing cost.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An optical member for a display apparatus, the optical member comprising:
a transparent resin material; and
a first optical pattern formed on a surface of the transparent resin material, and including a plurality of first shielding parts filled with a light absorbing substance and a conductive substance.

2. The optical member of claim 1, further comprising:
a second optical pattern formed on the first optical pattern, and including a plurality of second shielding parts crossing the first optical pattern and having a conductive substance.

3. The optical member of claim 2, further comprising:
an electrode disposed on at least a portion of an edge portion of the transparent resin material in such a manner as to cover an end of the second optical pattern.

4. The optical member of claim 2, wherein the first optical pattern has a stripe shaped-pattern parallel to a side of the transparent resin material, and the second optical pattern has a stripe shaped-pattern perpendicular to the first optical pattern.

5. The optical member of claim 1, wherein each of the first shielding parts has a wedge shape, a trapezoid shape, a U-shape, or a semicircular shape in its cross-sectional area.

6. The optical member of claim 3, wherein a width of the electrode is about 10 to 50 mm.

7. The optical member of claim 3, wherein the electrode is disposed on a first edge portion adjacent to a side of the transparent resin material and a second edge portion adjacent to another side of the transparent resin material crossing the side of the transparent resin material.

8. The optical member of claim 3, wherein the electrode is disposed on the entire edge portion of the transparent resin material.

9. The optical member of claim 2, wherein each line width of the second shielding parts is about 5 to 30 μm, each thickness thereof is less than about 30 μm, and each interval therebetween is about 0.3 to 100 mm.

10. The optical member of claim 1, wherein each of the first shielding parts includes an electromagnetic wave-shielding portion with a conductive substance and an external light-shielding portion with a light absorbing substance.

11. The optical member of claim 10, wherein the external light-shielding portion is formed on an upper portion of each of the first shielding parts, and the electromagnetic wave-shielding portion is formed on a lower portion of each of the first shielding parts.

12. The optical member of claim 10, wherein the electromagnetic wave-shielding portion is formed on an upper portion of the each of the first shielding parts, and the external light-shielding portion is formed on a lower portion of each of the first shielding parts.

13. The optical member of claim 1, wherein the conductive substance is at least one substance selected from the group consisting of a carbon nanotube, a metal powder, and a metal oxide powder.

14. The optical member of claim 1, wherein the conductive substance includes metal particles having a mean particle size of 10 μm or less.

15. The optical member of claim 10, wherein a volume ratio between the light absorbing substance and the conductive substance in the external light-shielding portion is about 9:1 to 7:3.

16. The optical member of claim 10, wherein a volume ratio between the light absorbing substance and the conductive substance in the electromagnetic wave-shielding portion is about 1:9 to 3:7.

17. The optical member of claim 1, wherein each of the first shielding parts includes:
to 40 wt % of a polymer resin,
1 to 10 wt % of the light absorbing substance, and
50 to 85 wt % of the conductive substance.

18. The optical member of claim 2, wherein the second shielding parts are formed by screen-printing with a metal paste or by inkjet-coating with a metal paste.

19. The optical member of claim 3, wherein the electrode is formed using a metal paste or a metal tape.

20. A filter for a display apparatus, the filter comprising:
a transparent substrate;
an optical member formed on a surface of the transparent substrate and including:
i) a transparent resin material, and
ii) a first optical pattern formed on a surface of the transparent resin material and including a plurality of first shielding parts filled with a light absorbing substance and a conductive substance;
a color correction layer formed on the optical member and containing at least one colorant for selectively absorbing a light; and
an anti-reflection layer formed on another surface of the transparent substrate.

21. The filter of claim 20, wherein the optical member further includes:
iii) a second optical pattern formed on the first optical pattern, and including a plurality of second shielding parts crossing the first optical pattern and having a conductive substance.

22. The filter of claim 20, wherein each of the first shielding parts includes an external light-shielding portion with the light absorbing substance, and an electromagnetic wave-shielding portion with the conductive substance.

23. The filter of claim 20, wherein each of the first shielding parts has a wedge shape, a trapezoid shape, a U-shape, or a semicircular shape in its cross-sectional area, and includes an external light-shielding portion in which a concentration of the light absorbing substance is greater than that of the conductive substance, and an electromagnetic wave-shielding portion in which a concentration of the conductive substance is greater than that of the light absorbing substance.

24. A filter for a display apparatus, the filter comprising:
a transparent substrate;
an electromagnetic wave-shielding layer formed on a surface of the transparent substrate and including a conductive layer formed by alternatively stacking a metal thin film and a metal oxide thin film one to three times;
an optical member formed on the electromagnetic wave-shielding layer and including:
i) a transparent resin material; and
ii) a first optical pattern formed on a surface of the transparent resin material and including an external light-shielding portion with a light absorbing substance and an electromagnetic wave-shielding portion with a conductive substance, respectively;
a color correction layer formed on the optical member and containing at least one colorant for selectively absorbing a light; and
an anti-reflection layer formed on another surface of the transparent substrate.

25. The filter of claim 24, wherein the optical member further includes a second optical pattern formed on the first optical pattern, and including a plurality of second shielding parts crossing the first optical pattern and having a conductive substance.
